(19) United States
(12) Patent Application Publication
(10) Pub. No.: US 2002/0154940 A1
(43) Pub. Date: Oct. 24, 2002

(54) Device for damped elastic connection and method of manufacturing it

(76) Inventor: Nicolas Pierre Georges Certain, Aix En Provence (FR)

Correspondence Address: HENDERSON & STURM LLP, 1213 MIDLAND BUILDING, 206 SIXTH AVENUE, DES MOINES, IA, 50309-4076, US

(21) Appl. No.: 09/992,803

(22) Filed: Nov. 19, 2001

(30) Foreign Application Priority Data
Dec. 26, 2000 (FR) 00 17055

(51) Int. Cl. F16D 1/00; F16D 3/00

(52) U.S. Cl. 403/24

(57) ABSTRACT

The device comprises at least two coaxial viscoelastic sleeves, one inside the other, with the interposition of an intermediate ring and between an internal ring and an external ring, the set thus formed being fixed around an internal armature and inside the outer sheath of an external armature, the armatures being connected by connecting members to the two parts etween which the device is mounted. The shear moduli and the geometry of the two elastomer sleeves are chosen so that their stiffness is identical.

The invention relates to a device for the damped elastic connection of two parts, and to a method of manufacturing it.

The damped elastic connecting device of the invention is more particularly usable as a drag damper intended to be mounted between, on the one hand, a rotor blade of a rotary-wing aircraft such as a helicopter and, on the other hand, an adjacent blade of this rotor, in a drag damper inter-blade configuration or, more conventionally, the hub of this rotor.

Such a drag damper, also known as a drag frequency adapter, for the reasons given in FR 2 063 969, to which reference can be made for further details on this subject, is a device for the damped elastic connection between a blade and the hub or another blade of the rotor, and which behaves like an elastic return strut with built-in damping, returning the two parts it connects to a neutral position and providing a certain damping of the alternating relative movements of the two parts about this neutral position when the said strut is stressed essentially axially by these alternating movements.

The device for damped elastic connection according to the invention is of the general type in which a viscoelastic material, generally an elastomeric material with high remanence in deformation, that generates damping, is stressed in shear between rigid armatures connected to the two parts between which the device for damped elastic connection is mounted.

Devices for damped elastic connection of this overall type are described in particular in FR 2 063 969, FR 2 111 845, FR 2 127 061, FR 2 672 947, FR 2 677 723 and WO 94/15113.

In those documents, the viscoelastic material is shaped into flat, curved or tubular layers which are secured, by bonding or vulcanizing, to armatures arranged as flat or curved metal plates, or as substantially coaxial tubular armatures.

To increase the fatigue strength and therefore the life of such drag dampers, FR 2 111 845, in the case of flat or curved elastomer sheaths, and FR 2 672 947 and FR 2 677 723 in the case of a layer of elastomer in the form of a tubular sleeve, have already proposed preloading of the viscoelastic material in compression in a direction perpendicular to the direction of the shear forces and, more specifically, radially from the outside inwards in the case of an elastomer sleeve, so as to eliminate the residual stresses which develop in the viscoelastic material as a result of its shrinkage upon cooling after moulding and which cause breaks in adhesion, the precompressing of the viscoelastic material having no appreciable effect on its damping ability, but increasing its durability.

At the present time, main rotors of low-and medium-tonnage helicopters and tail rotors of high-tonnage helicopters are equipped with drag frequency adapters for their blades, which adapters are of the viscoelastic cylindrical type, with a tubular layer of elastomer between two coaxial tubular armatures and stressed in compression after moulding, as proposed in FR 2 672 947 and FR 2 677 723.

In addition, frequency adapters for adapting helicopter rotor blades in terms of drag and of the viscoelastic type have also evolved, over the past few years, in two other directions.

One of them is the adopting of “meniscus” shapes for the axial end faces of the elastomer layers, which therefore have curved free surfaces with the concave side facing axially outwards and which have made it possible to minimize the local overstresses in the elastomer and therefore to obtain a very appreciable increase in the mean service lives before the frequency adapters need to be replaced or changed.

The other direction of change for these frequency adapters stems directly from progress made by the suppliers in the field of elastomeric materials, particularly silicone elastomers, which have loss angles that can rise to as high as about 45° making it possible, in certain instances, to dispense with the addition of a fluid damping stage as proposed, for example, in FR 2 063 969.

Although the new silicone materials have excellent properties, particularly in terms of damping, and the drag frequency adapters of the viscoelastic cylindrical type display the advantages of a reduction of the free surface areas of the tubular layer of elastomer with a simpler and more effective definition of the meniscus profiles, by comparison with an embodiment using sheets of elastomer, and a saving of 30 to 50% on the cost of the adapter, the use of drag frequency adapters of the known viscoelastic cylindrical type soon reaches its limits for the reasons explained hereinbelow, whilst the helicopters, and therefore the rotors with which they are equipped, increase in size. In particular, in this case, a viscoelastic cylindrical frequency adapter cannot be engineered for fatigue strength, and a heavier and more expensive sheet-type viscoelastic adapter has to be used.

As regards the limits on current elastomeric cylindrical frequency adapters, and outside of the meniscus shape of the annular axial end faces of the elastomer layer which is adopted, as already mentioned hereinabove, for reasons of local stress optimization, the cylindrical elastomer layer has the same axial length on the internal armature as on the external armature. Because of its tubular cylindrical shape, the area, and therefore the stiffness, of the interior elemental layer of the elastomer sleeve are lower than the area and stiffness of the exterior elemental layer of this same elastomer sleeve, and therefore the stress on the interior elemental layer, under a force applied to the members connecting the armatures of the frequency adapter to the parts between which the latter is mounted, increases with the thickness of the elastomer sleeve.

This remains acceptable on helicopters of low or medium tonnage, because since the dynamic stresses are fairly low, the thicknesses of the elastomer sleeves are fairly low also.

In the case of more heavily stressed drag frequency adapters, and as proposed in WO 94/15113, one solution might be to modify the profile of the cross section of the elastomer sleeve in axial section, giving the various elemental layers of this elastomer sleeve an axial length that is inversely proportional to their radius, or alternatively an axial length and a radius which are such that their product is constant, so as to have elemental layers of the elastomer sleeve which have the same surface area, and therefore the same stiffness, so as to obtain uniform stressing throughout the elastomer sleeve.

However, in reality, this proposal does not afford the hoped-for advantages because, on the one hand, the meniscus shape, which is incidentally needed for the reasons mentioned hereinabove, at the annular axial end faces of the elastomer sleeve, disturbs the optimization that consists in giving the axial length and radius of the elemental layers of the elastomer sleeve a constant product and, on the other hand, the fact that the elastomer sleeve is no longer locally confined greatly reduces the effects of the variation of its axial length.

In cases where the elastomer sleeve is too thick by comparison with the radius of the internal armature, WO 94/15113 proposes laminating the elastomer sleeve into various tubular layers with different mechanical properties which are coaxially fitted one inside the other, but without the possibility of stressing the various layers in compression, something which seriously prejudices their fatigue performance.

In WO 94/15113, it is proposed that the various layers of the elastomeric material have different properties, varying from a low ability to damp in the case of the radially innermost layer, to a high damping ability in the case of the radially outermost layer, that is to say having a stiffness that increases from the internal layer to the external layer.

Furthermore, WO 94/15113 also proposes that contiguous layers of elastomer of the viscoelastic sleeve be separated radially from one another by a rigid metallic cylindrical ring, making it easier for the heat produced in the stressed elastomer to be removed and to increase the axial rigidity. However, in this case, axial recesses are formed in the contiguous layers of elastomer and the cross section of these recesses increases with the radius so that the area, in the circumferential direction, of each elemental layer of elastomer of the viscoelastic sleeve is more or less constant from the internal armature to the external armature, as described with reference to FIGS. 6 and 9 of that document.

The present invention sets out to remedy the abovementioned disadvantages of a device according to WO 94/15113, and to obtain a device for damped elastic connection that better satisfies the various requirements of current practice, when used as a heavily loaded frequency adapter, than those proposed by WO 94/15113, and, in particular, in which it is possible to stress the various layers of elastomer in compression.

One object of the invention is to propose a technological configuration which makes it possible to use devices for damped elastic connection of the viscoelastic cylindrical type to produce drag dampers or drag frequency adapters which are heavily loaded.

Another object of the invention is to propose a device for damped elastic connection of the type known from WO 94/15113, having at least two tubular cylindrical layers of viscoelastic material, but the structure of which is such that each tubular layer can be precompressed at the time of manufacture, given the need for a layer of elastomer, particularly one made of silicone, to be precompressed so as to offer sufficient fatigue life, so that the device for damped elastic connection according to the invention can be used as a heavily loaded drag damper or drag frequency adapter on rotors of high-tonnage rotary-wing aircraft.

To this end, the invention proposes a device for the damped elastic connection of two parts, the device comprising at least one set of at least two tubular cylindrical sleeves of viscoelastic material fitted one inside the other substantially coaxially with the interposition of a rigid cylindrical and substantially coaxial ring between two contiguous viscoelastic sleeves of the said set so that, for each pair of two contiguous sleeves, one of the two sleeves is an internal sleeve secured, by its internal cylindrical lateral face, to an external cylindrical lateral face facing it belonging to an internal rigid ring and, by its external cylindrical lateral face, to an internal cylindrical lateral face facing it belonging to an intermediate rigid ring separating the said internal sleeve from the other sleeve of the said pair of sleeves, which is an external sleeve secured, by its internal cylindrical lateral face, to an external cylindrical lateral face of the said intermediate ring and, by its external cylindrical lateral face, to an internal cylindrical lateral face of an external rigid ring, the innermost ring and the outermost ring of the said set being secured, respectively, to an internal armature and to an external armature, each of which is connected to a respective one of two members for connection to the said parts, as known from WO 94/15113, and which is characterized in that, for each pair of two contiguous sleeves of the said set, the internal sleeve and the external sleeve are made of a viscoelastic material which has a shear modulus g1 and g2 respectively, and have an axial length L1 and L2 respectively, an inside radius R1 and R2 respectively and a thickness e1 and e2 respectively, giving them a geometry such that the following formula is substantially satisfied:

$$g 1 \cdot \frac{L 1}{ln ( 1 + \frac{e 1}{R 1} )} = g 2 \cdot \frac{L 2}{ln ( 1 + \frac{e 2}{R 2} )}$$

There is thus obtained a device in which the stiffness of the various viscoelastic sleeves is identical, while at the same time being compatible with annular axial end faces of the elastomer sleeves in the shape of a meniscus, which makes it possible to enjoy the corresponding advantages even on drag frequency adapters which are highly stressed.

In the latter case, when each of the two annular axial end faces of each viscoelastic sleeve is shaped as a meniscus delimited by a curved free surface with the concave side facing axially outwards, the axial length of each sleeve is measured between the bottoms of the meniscuses of its two annular end faces.

Advantageously, the viscoelastic material of the sleeves is an elastomer, and preferably a silicone elastomer, in particular with a high loss angle value that may be as high as about 45°.

In the device according to the invention, the overall structure of which has been set out hereinabove, each viscoelastic sleeve is advantageously moulded and preloaded in compression between the two rigid rings to which the said sleeve is secured by its internal and external cylindrical lateral faces.

To this end, for at least one pair of contiguous sleeves, the external sleeve is preloaded by shrink-fitting the corresponding external rigid ring, it being possible for this shrink-fitting of the external rigid ring to be brought about by plastic deformation of the said external rigid ring radially inwards.

Simultaneously or alternatively, for at least one pair of contiguous sleeves, the internal sleeve is preloaded by radial expansion of the corresponding internal rigid ring, it being possible for this radial expansion of the said internal rigid ring outwards to be brought about by plastic deformation of this internal ring.

When such a set of at least two viscoelastic sleeves is thus preloaded, it is advantageously also fitted and shrink-fitted, preferably by shrinking-on under the action of heat, into the said external armature, arranged as an outer sheath, and/or around the said internal armature, of cylindrical shape.

As an alternative, the outermost ring of the said set may, at its axial end facing towards the connecting member to which the said outermost ring is connected, have a radially thicker part to which the external armature is removably connected by fixing means such as axial screws.

In this case, the outermost ring of the said set may be shrunk-on by cold rolling of its part extending in line with the outermost sleeve of the said set.

In other alternative forms, at least one of the innermost and outermost rings of the said set may be incorporated into the internal armature or external armature, respectively.

In all cases, it is advantageous for the two connecting members to be threaded ball ends with screw threads of opposite hand, or of the same hand but different pitch, each of the said threaded ends being screwed into a tapped bore of one of the external and internal armatures, respectively, so as to allow the axial length of the connecting device to be adjusted, locked locking nuts being screwed on to the threaded ends and pressed against the said armatures so as to fix the said axial length of the connecting device after its adjustment.

A device for damped elastic connection according to the invention and as set out hereinabove can be manufactured using a method comprising, for manufacturing the said at least one set of at least two viscoelastic sleeves, at least the operations consisting in:

moulding the innermost sleeve of the said set between, on the one hand, the innermost ring of the said set or the internal armature and, on the other hand, an intermediate ring,

shrinking the said intermediate ring so as to preload the innermost sleeve in compression,

moulding a contiguous sleeve around the said intermediate ring and between the latter and another ring which is radially on the outside,

shrinking the said other ring which is radially on the outside so as to preload the said contiguous sleeve in compression, and so on until the outermost sleeve of the said set is moulded and the outermost ring of the said set is shrunk.

As an alternative, the method of manufacture may comprise, for manufacturing the said at least one set of at least two viscoelastic sleeves, at least the operations consisting in:

moulding all the viscoelastic sleeves at the same time, using a very-high-pressure moulding operation that limits the effect of the post-moulding shrinkage and precompressing the sleeves at the time of moulding,

the innermost sleeve of the said set being moulded directly on to the said internal armature or on to the innermost ring of the said set, and

the outermost sleeve being moulded directly on to the said external armature or on to the outermost ring of the said set.

Other features and advantages of the invention will become apparent from the description given hereinbelow by way of non-limiting examples of some exemplary embodiments which are described with reference to the appended drawings, in which:

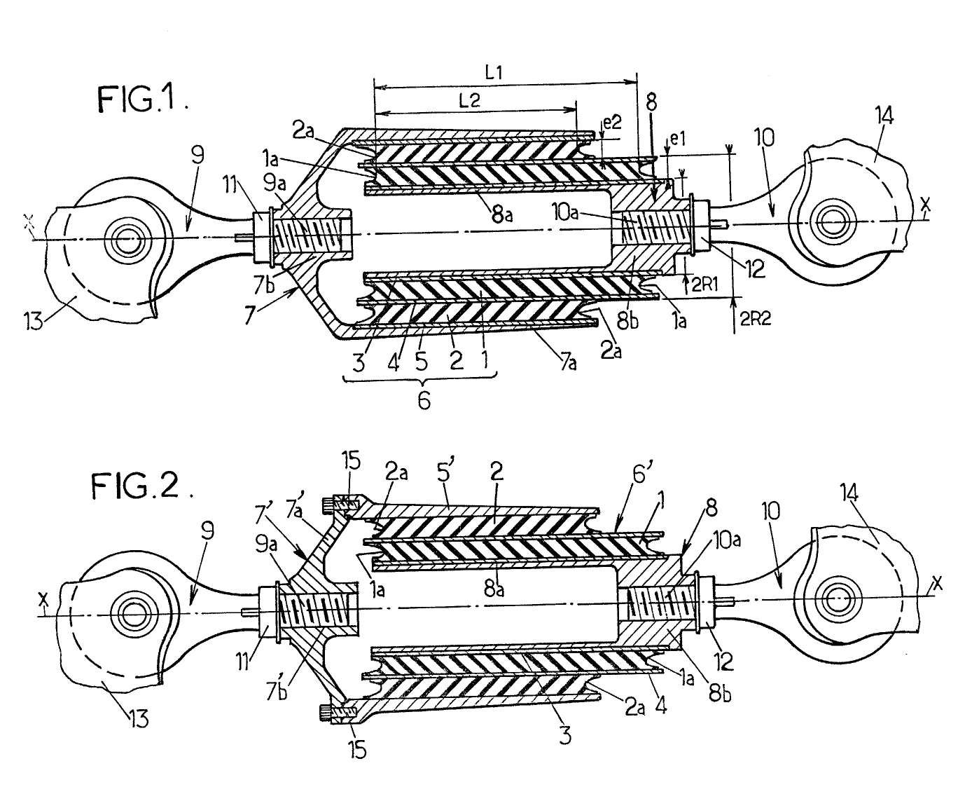

FIG. 1 is a schematic view in axial section of a first example of a device for damped elastic connection with just one set of two cylindrical elastomer sleeves that can be precompressed at the time of manufacture, and

FIG. 2 is a view similar to FIG. 1 of an alternative form of the device of FIG. 1.

The drag frequency adapter for helicopter rotor blades in FIG. 1 comprises two sleeves 1 and 2 made of viscoelastic material, which is an elastomeric material, and more specifically a silicone elastomer with a high loss angle which may be as high as about 45°. These two sleeves 1 and 2 are tubular and have a cylindrical overall shape with a circular cross section, and each of the two annular axial end faces 1a or 2a of each sleeve 1 or 2 is shaped as a meniscus, delimited by a curved free surface with the concave side facing axially outwards.

The two sleeves 1 and 2 are fitted one inside the other, and one of the sleeves is an internal sleeve 1 extending axially between an internal cylindrical rigid ring 3 and an intermediate cylindrical rigid ring 4, while the other sleeve is an external sleeve 2 which extends axially between the intermediate ring 4 and an external rigid cylindrical ring 5.

The three rings 3, 4 and 5 are rings of circular cross section and metallic, made of a ductile alloy or a metal, for example of an aluminium alloy.

The two sleeves 1 and 2 and the three rings 3, 4 and 5 are tubular elements which are substantially coaxial, about the longitudinal axis X-X of the frequency adapter, and each of the sleeves 1 or 2 is secured to the two rings 3 and 4 or 4 or 5 between which it extends. This securing is brought about by bonding or vulcanizing at the time of the moulding of the sleeves 1 and 2 between the rings 3, 4 and 5. More specifically, the internal sleeve 1 is secured, by its internal cylindrical lateral face, to the external cylindrical lateral face of the internal ring 3 and, by its external cylindrical lateral face, to the internal cylindrical lateral face of the intermediate ring 4. Similarly, the external sleeve 2 is secured, by its internal cylindrical lateral face, to the external cylindrical lateral face of the intermediate ring 4 and, by its external cylindrical lateral face, to the internal cylindrical lateral face of the external ring 5, all these cylindrical lateral faces, each one facing another, on the sleeves 1 and 2 and on the rings 3, 4 and 5 being substantially coaxial about the longitudinal axis X-X.

In the known way, the sleeves 1 and 2 are moulded between the rings 3, 4 and 5 hot and under pressure.

The geometry of each of the elastomer sleeves 1 and 2 is determined by its inside radius R1 or R2 respectively, its axial length L1 or L2 respectively, measured between the bottoms of the meniscuses of the corresponding two annular axial end faces 1a or 1b and its thickness e1 or e2 respectively. According to a technical approach specific to the invention, the geometry of the elastomer sleeves 1 and 2 is chosen so that their stiffness is identical, that is to say that the following equality is observed:

$$\frac{L 1}{ln ( 1 + \frac{e 1}{R 1} )} = \frac{L 2}{ln ( 1 + \frac{e 2}{R 2} )}$$

where: In is the Neperian logarithm, when the viscoelastic material of the sleeves 1 and 2 has the same shear modulus.

However, it is possible for each of the two sleeves 1 and 2 to be made with one of two different viscoelastic materials respectively, these having different shear moduli g1 and g2 respectively. When such is the case, the geometry of the two sleeves 1 and 2 is such that the following equality is satisfied:

$$g 1 \cdot \frac{L 1}{ln ( 1 + \frac{e 1}{R 1} )} = g 2 \cdot \frac{L 2}{ln ( 1 + \frac{e 2}{R 2} )}$$

Either of the two formulae given hereinabove needs to be substantially satisfied once the two elastomer sleeves 1 and 2 have been precompressed during manufacture.

After moulding the two elastomer sleeves 1 and 2 hot and under pressure between the cylindrical rings 3, 4 and 5, the elastomer of the external sleeve 2 is preloaded by shrinking the external ring 5, and the elastomer of the internal sleeve 1 is preloaded by radially expanding the internal ring 3 outwards once the set 6 consisting of the two sleeves 1 and 2 and of the three rings 3, 4 and 5 has been manufactured. Thus, the elastomer of each of the sleeves 1 and 2 is preloaded in compression between the two rigid rings 3 and 4 or 4 and 5 to which the sleeve 1 or 2 in question is secured by its internal and external cylindrical lateral faces.

The shrinking of the external ring 5 is, for example, performed by passing the set 6 through a die of a diameter smaller than the outside diameter of this set 6, that is to say smaller than the outside diameter of the external ring 5, which causes plastic deformation of the external ring 5 radially inwards.

Outward radial expansion of the internal ring 3 is performed, for example, by passing a core of a diameter greater than the inside diameter of the internal ring 3 axially through the set 6, causing plastic deformation in radial expansion of the internal ring 3.

Other methods of plastic deformation of the internal ring 3 radially outwards and of the external ring 5 radially inwards may be implemented in order to preload the elastomer of the sleeves 1 and 2 of the set 6 in compression.

The set 6, thus preloaded in its two sleeves 1 and 2, is then fitted via its external ring 5 into an outer sheath 7a, previously heated and therefore expanded in terms of radial expansion, of an external armature 7, and via its internal ring 3, around the tubular part 8a, previously cooled and therefore radially shrunk inwards, of a cylindrical internal armature 8, so that once the sheath 7a of the external armature 7 cools and the tubular part 8a of the internal armature 8 warms up to approximately the ambient service temperature, the set 6 is secured together by shrink-fitting into the outer sheath 7a and on to the part 8a of the cylindrical internal armature 8.

Each of the internal 8 and external 7 armatures is connected to a respective one of two connecting members 9 and 10 allowing the frequency adapter thus formed to be attached to the two parts between which it is to be mounted, for example, at one end, a laterally projecting yoke 13 of a connecting member that connects a rotor blade to the hub of this rotor and, at the other end, a laterally projecting yoke 14 on the edge of the rotor hub or on the connecting member of an adjacent blade of the rotor.

The connecting members 9 and 10 are threaded ball ends each screwed via a threaded rod 9a or 10a into a tapped bore formed axially in a central and axial part 7b or 8b of the corresponding external 7 or internal 8 armature.

The ends 9 and 10 are identical, except as regards the threads of the threaded rods 9a and 10a, which are, as is known, of opposite hand, that is to say screw in opposite directions or, as an alternative and as a preference, which are of the same hand (right-handed by convention), but have different pitch. Precise adjustment of the (axial) length of the adapter is then very easy because, for one turn of the adapter body, consisting of the set 6 and of its internal 8 and external 7 armatures, about its longitudinal axis X-X, relative to the ends 9 and 10, the distance between these ends 9 and 10 varies by the difference of the pitch of the thread of their threaded rods 9a and 10a. The ends 9 and 10 are attached to the yokes 13 and 14 by pins passing through the latter and through the balls of the ends 9 and 10, in a way which is well known.

Nuts 11 and 12, screwed on to the threaded rods 9a and 10a of the ends 9 and 10, allow the latter to be locked, so as to give the adapter a determined length, by axially tightening the nuts 11 and 12 against the central parts 7b and 8b of the external 7 and internal 8 armatures. In a known way, these nuts 11 and 12 are locked with respect to the adjacent armatures 7 and 8 by locking wire or by a locking washer, so as to fix the axial length of the adapter once its length has been adjusted.

This configuration of a device for damped elastic connection, described in its application to a drag damper or drag frequency adapter for helicopter rotor blades, makes it possible, within a given volume, to optimize the fatigue behaviour of the elastomer by reducing the disparity in local stressing in the viscoelastic sleeves 1 and 2 by virtue of the special geometry thereof, and also, to mould these two elastomer sleeves 1 and 2 in a single shot, the elastomer of which sleeves can then be preloaded in compression so as to eliminate the shrinkage effect, due to post-moulding cooling, and thus ensure good fatigue behaviour.

Furthermore, and as known from WO 94/15113, the configuration of an adapter according to FIG. 1 makes it possible to improve the removal of energy dissipated in the elastomer of the sleeves 1 and 2 by conduction through the intermediate cylindrical ring 4, and to increase the radial stiffness of the adapter, something which is highly advantageous in the case of inter-blade adapters (each mounted between two adjacent blades of the rotor), which are radially subjected to the centrifugal field, so as to reduce the disparity in the local loading of the elastomer of the sleeves 1 and 2.

As an alternative, as depicted in FIG. 2, the external ring of the set with two elastomer sleeves may be incorporated into the outer sheath of the external armature 7′ and with this sheath form a single tubular part 5′, with a cylindrical internal lateral surface, but with a frustoconical external lateral surface because this external ring or outer sheath 5′ has a radially thicker part at its axial end facing towards a transverse endplate 7′c of the external armature 7′, this endplate 7′c being secured to the central part 7′b of this same external armature 7′ through which the tapped axial bore that accommodates the threaded rod 9a of the corresponding threaded ball end 9 passes.

In this alternative form, the external ring 5′ of the set 6′, which incidentally is for the rest identical to the set 6 of the previous example, in that it comprises the same internal 1 and external 2 elastomer sleeves and the same internal 3 and intermediate 4 rings, is fixed to the endplate 7′c of the external armature 7′ by axial screws 15 passing through the external radial periphery of the endplate 7′c and which are accommodated in the thicker axial end part of the external ring 5′.

The benefit of connecting the external ring 5′ to the external armature 7′ removably, by fixing means which allow these two elements 5′ and 7′ to be secured together and detached from one another, is that the internal meniscuses 1a and 2a of the axial end faces of the elastomer sleeves 1 and 2 can be inspected precisely when the connection by means of the screws 15 is dismantled.

In this alternative form in which the other components of the adapter are identical to the corresponding components of the previous example, and are therefore identified by the same numerical references, the compressive preload on the elastomer of the external sleeve 2 is provided by shrinking the external ring 5′, which shrinkage is achieved by plastic deformation radially inwards by cold rolling of the zone of this external armature 5′ which lies in line with the elastomer of the external sleeve 2.

According to other alternative forms, one and/or other of the internal 3 and external 5 rings of the example of FIG. 1 may be incorporated into and of one piece with the cylindrical tubular part 8a of the internal armature 8 and/or the external tubular part forming the outer sheath 7a of the external armature 7.

In the embodiments of FIGS. 1 and 2, the adapter comprises just one set 6 or 6′ with just two elastomer sleeves 1 and 2. However, the adapter may comprise several sets such as 6 or 6′, spaced apart axially but still substantially between an internal armature and an external armature and, in addition, the set 6 or 6′ or each of several axially stacked sets 6 or 6′ may comprise more than two elastomer sleeves such as 1 and 2.

In particular, with reference to FIG. 1, if the set 6 comprises a third elastomer sleeve, surrounding the other two 1 and 2, it is obvious that this third sleeve will be secured around the ring 5, which will then be a second intermediate ring, an additional external ring surrounding the additional elastomer sleeve and being itself surrounded by an outer sheath such as 7a. In such an embodiment, according to the invention, the formulae given above will need to be satisfied for each pair of two contiguous elastomer sleeves, namely for a first pair comprising the sleeves 1 and 2 and for a second pair comprising the sleeve 2 and the third sleeve, the outermost one of the set, which is itself surrounded by an additional ring, which is the outermost one of the set.

In the second pair of two contiguous elastomer sleeves, the sleeve 2 is the internal sleeve and the ring 4 is the internal ring, while the ring 5 is the intermediate ring, the external sleeve being the third sleeve or additional sleeve, and the external ring being the ring which surrounds this third sleeve. However, the ring 3 remains the innermost ring of the set, the outermost ring of which is the additional ring surrounding the third sleeve.

In general, the adapter comprises one or more sets, each set itself comprising two or more than two elastomer sleeves separated by cylindrical rigid rings.

Such a set may be manufactured by first of all moulding the innermost sleeve of the set between, on the one side, the innermost ring of this set and, on the other side, an intermediate ring, for example, in the case of FIG. 1, by moulding the internal sleeve 1 between the internal ring 3 and the intermediate ring 4. The elastomer of the first moulded sleeve is then preloaded in compression by shrinking the first intermediate ring, in this instance the ring 4 in FIG. 1. The adjacent sleeve, such as the sleeve 2 of FIG. 1, is then moulded around the intermediate ring which has just been shrunk, between the latter and another ring radially on the outside, such as the ring 5 of FIG. 1. This other ring 5 is then shrunk, so as to preload the second moulded sleeve such as 2 in compression, and so on and so forth until the outermost sleeve of the set has been moulded and the outermost ring of this set has been shrunk.

In this case, it is obvious that the innermost ring of the set, such as the ring 3 of FIG. 1, may be omitted, and the innermost sleeve, such as the sleeve 1, may be moulded directly on to and around the tubular part 8a of the internal armature 8. This alternative form corresponds to the one mentioned hereinabove in which the innermost ring is incorporated into the internal armature.

Such a set may also be manufactured by simultaneous and very-high-pressure moulding of all the elastomer sleeves, the moulding pressure being substantially maintained after moulding and high enough to make it possible to limit the effect of the elastomer of the sleeves shrinking after moulding and cooling. The elastomer sleeves are not precompressed by shrinking the internal or external rings between which these sleeves are moulded, but by the effect of the very high pressure during moulding and cooling.

In this case, the internal ring, such as the ring 3 of FIG. 1, may be omitted or incorporated into the tubular part 8a of the internal armature 8, and the internal sleeve, such as 1 in FIG. 1, may be moulded directly on to and around this tubular part 8a of the internal armature 8. Similarly, the external ring, such as the ring 5 of FIG. 1, may be omitted or incorporated into the outer sheath 7a of the external armature 7, the external sleeve such as 2 then being moulded directly on to the internal lateral face of the outer sheath 7a. In this case, the sheath 7a may be not shrunk by radial deformation inwards in order to compress the elastomer of the external sleeve 2 because sufficient precompression can be provided by the very high pressure of moulding and of cooling.

There are thus produced devices for damped elastic connection that can be used as drag dampers or drag frequency adapters under heavy load on high-tonnage helicopter rotors, and which have a mass which is not appreciably greater than that of the frequency adapters of the state of the art while having a cost that is 20% to 30% lower, by construction, and which offer a mean time between replacements (MTBR) which is very much longer than that of the current devices.

1. A device for the damped elastic connection of two parts, the device comprising at least one set of at least two tubular cylindrical sleeves of viscoelastic material fitted one inside the other substantially coaxially with the interposition of a rigid cylindrical and substantially coaxial ring between two contiguous viscoelastic sleeves of said set so that, for each pair of two contiguous sleeves, one of the two sleeves is an internal sleeve secured, by an internal cylindrical lateral face, to an external cylindrical lateral face facing it belonging to an internal rigid ring and, by an external cylindrical lateral face of said internal sleeve to an internal cylindrical lateral face facing it belonging to an intermediate rigid ring separating said internal sleeve from the other sleeve of said pair of sleeves, which is an external sleeve secured, by an internal cylindrical lateral face, to an external cylindrical lateral face of said intermediate ring and, by an external cylindrical lateral face of said internal sleeve, to an internal cylindrical lateral face of an external rigid ring, an innermost ring and an outermost ring of said set being secured, respectively, to an internal armature and to an external armature, each of which is connected to a respective one of two members for connection to said parts,
wherein, for each pair of two contiguous sleeves of said set, the internal sleeve and the external sleeve are made of a viscoelastic material which has a shear modulus g1 and g2 respectively, and have an axial length L1 and L2 respectively, an inside radius R1 and R2 respectively and a thickness e1 and e2 respectively, giving them a geometry such that the following formula is substantially satisfied:
$$g 1 \cdot \frac{L 1}{ln ( 1 + \frac{e 1}{R 1} )} = g 2 \cdot \frac{L 2}{ln ( 1 + \frac{e 2}{R 2} )} .$$

2. A device according to claim 1, wherein each of two annular axial end faces of each viscoelastic sleeve is shaped as a meniscus delimited by a curved free surface with a concave side facing axially outwards, and said axial length of each sleeve is measured between bottoms of the meniscuses of said two annular end faces of said sleeve.

3. A device according to claim 1, wherein the viscoelastic material of the sleeves is an elastomer.

4. A device according to claim 3, wherein the elastomer of the sleeves is a silicone elastomer with a high loss angle value as high as about 45°.

5. A device according to claim 1, wherein each viscoelastic sleeve is moulded and preloaded in compression between the two rigid rings to which said sleeve is secured by its internal and external cylindrical lateral faces.

6. A device according to claim 5, wherein for at least one pair of contiguous sleeves, the external sleeve is preloaded by shrink-fitting the corresponding external rigid ring.

7. A device according to claim 6, wherein said shrink-fitting of the external rigid ring is brought about by plastic deformation of said external rigid ring radially inwards.

8. A device according to claim 5, wherein for at least one pair of contiguous sleeves, the internal sleeve is preloaded by radial expansion of the corresponding internal rigid ring.

9. A device according to claim 8, wherein said radial expansion of said internal rigid ring outwards is brought about by plastic deformation of the internal rigid ring.

10. A device according to claim 1, wherein said set of at least two viscoelastic sleeves is shrink-fitted, into said external armature, arranged as an outer sheath, and/or around said internal armature, of cylindrical shape.

11. A device according to claim 1, wherein the outermost ring of said set has, at an axial end facing towards the connecting member to which said outermost ring is connected, a radially thicker part to which the external armature is removably connected by fixing means.

12. A device according to claim 11, wherein the outermost ring of said set is shrunk-on by cold rolling of its part extending in line with the outermost sleeve of said set.

13. A device according to claim 1, wherein at least one of the innermost and outermost rings of said set is incorporated into the internal armature or external armature, respectively.

14. A device according to claim 1, wherein said two connecting members are threaded ball ends with screw threads of opposite hand, or of the same hand but different pitch, each of said threaded ends being screwed into a tapped bore of one of the external and internal armatures, respectively, so as to allow the axial length of the connecting device to be adjusted, locked locking nuts being screwed on to the threaded ends and pressed against the said armatures so as to fix said axial length of the connecting device after its adjustment.

15. A method of manufacturing a device for damped elastic connection according to claim 1, the method comprising for manufacturing said at least one set of at least two viscoelastic sleeves, at least the steps consisting in:
moulding the innermost sleeve of said set between, on the one hand, the innermost ring of said set or the internal armature and, on the other hand, an intermediate ring,
shrinking said intermediate ring so as to preload the innermost sleeve in compression,
moulding a contiguous sleeve around the said intermediate ring and between the latter and another ring which is radially on the outside,
shrinking said other ring so as to preload said contiguous sleeve in compression, and so on until the outermost sleeve of said set is moulded and the outermost ring of said set is shrunk.

16. A method of manufacturing a device for damped elastic connection according to claim 1, the method comprising, for manufacturing said at least one set of at least two viscoelastic sleeves, at least the steps consisting in:
moulding all the viscoelastic sleeves at the same time, using a very-high-pressure moulding operation that limits the effect of the post-moulding shrinkage and precompressing the sleeves at the time of moulding,
the innermost sleeve of said set being moulded directly on to said internal armature or on to the innermost ring of said set, and
the outermost sleeve being moulded directly on to said external armature or on to the outermost ring of said set.
